(19) United States
(12) Patent Application Publication
(10) Pub. No.: US 2016/0154945 A1
(43) Pub. Date: Jun. 2, 2016

(54) METHOD AND SYSTEM FOR CHANGING MEDICINE-TAKING SCHEDULE

(71) Applicant: LG CNS CO., LTD., Seoul (KR)

(72) Inventors: Jee Hyun KIM, Seoul (KR); Ki Hwan CHOI, Seoul (KR); Young Kook KIM, Seoul (KR); Hyun Jung PARK, Seoul (KR); Young Don HWANG, Seoul (KR)

(73) Assignee: LG CNS CO., LTD., Seoul (KR)

(21) Appl. No.: 14/557,229

(22) Filed: Dec. 1, 2014

(51) Int. Cl. G06F 19/00

(52) U.S. Cl. CPC G06F 19/3456; G06F 19/322

(57) ABSTRACT

A method performed at a terminal of a medical team user for changing a medicine-taking schedule includes generating a first medicine-taking schedule, transmitting the first medicine-taking schedule to a terminal of a patient, and receiving a medicine-taking schedule change request from the terminal of the patient. A further operation includes changing the first medicine-taking schedule to a second medicine-taking schedule when a time parameter of the first medicine-taking schedule is within a threshold value of a time parameter of the second medicine-taking schedule.

### BACKGROUND

1. Field of the Invention

The present invention relates, in general, to a method and system for changing a medicine-taking schedule and, more particularly, to a method and system for changing a medicine-taking schedule in consideration of a patient's living habits.

2. Description of the Related Art

Generally, there are very few persons who never take medicines at least once throughout their lives, with the exception of especially healthy persons. On the other hand, there are cases where specific diseases require patients to take medicine throughout their lives.

Typically, for a medicine-taking time, expected medication effects may be accomplished or maximized when a medicine is taken at regular time intervals depending on the ingredients of the medicine and the duration of medical effects of the medicine. However, such regular medicine-taking is very inconvenient, so that medicine-taking times are adjusted within an allowable range depending on the life styles and events of ordinary persons. Typical medicine-taking times include “after wake-up”, “before meals”, “after meals”, “before bedtime”, and the like.

In modern society, it is not easy for a person to easily carry medicine and remember to take the medicine at designated times when they are away from home, for example. Further, when away from home, a person may forget to bring their medicine, and thus are not able to take their medicine or may miss a designated medicine-taking time. This may result in a decrease in the effectiveness of the medication. Furthermore, in some cases, medicines that remain without being taken in a designated medication period may possibly be misused. Therefore, suitable medicine-taking directions, such as the carrying of a medicine, notification of a medicine-taking time, and checking of medicine-taking, must be provided to persons who take medicines.

However, there are limitations in that in a hospital, a doctor's office, a pharmacy, etc. in which medicines are prepared, directions only for medicine-taking times and methods can be given upon preparing medicines, and subsequent medicine-taking procedure is inevitably dependent on the memorization and diligent follow-through of a medicine taker. It is difficult to continually remind each individually medicine taker to take their medicines at the specified time.

Further, each person has different wake-up times, meal times, digestive capacities, and bedtimes depending on their physical conditions and living habits, so they may have different medicine-taking times, and thus it is not practical to designate universally specific medicine-taking times.

### SUMMARY

Presented herein is a method and system for changing a medicine-taking schedule and, more particularly, a method and system for changing a medicine-taking schedule in consideration of a patient's living habits by manually or automatically changing a medicine-taking time, and which can effectively manage each patient by allowing a medical team to monitor the patient's medicine-taking time.

In accordance with an aspect of the present invention, there is provided a method for changing a medicine-taking schedule, the method being performed by a medical team terminal, including generating a first medicine-taking schedule; transmitting the first medicine-taking schedule to a patient terminal; receiving a second medicine-taking schedule from the patient terminal; and determining whether to change the first medicine-taking schedule via an input by a medical team by comparing the first medicine-taking schedule with the second medicine-taking schedule.

In accordance with another aspect of the present invention, there is provided a system for changing a medicine-taking schedule, including a medicine-taking schedule management server for storing medicine-taking information of a patient; a patient terminal having an input unit for transmitting/receiving the medicine-taking information to/from the medicine-taking schedule management server, and requesting a change of a medicine-taking schedule or inputting actual medicine-taking information; and a medical team terminal having a communication unit for transmitting a final medicine-taking schedule, in which information about whether to change the medicine-taking schedule, based on the medicine-taking schedule change request or the actual medicine-taking information received from the patient terminal, is reflected, to the medicine-taking schedule management server.

According to some embodiments, a method performed at a terminal of a medical team user for changing a medicine-taking schedule includes generating a first medicine-taking schedule, transmitting the first medicine-taking schedule to a terminal of a patient, and receiving a medicine-taking schedule change request from the terminal of the patient. A further operation includes changing the first medicine-taking schedule to a second medicine-taking schedule when a time parameter of the first medicine-taking schedule is within a threshold value of a time parameter of the second medicine-taking schedule.

According to other embodiments, a system for changing a medicine-taking schedule includes a server configured to store medicine-taking information of a patient; a patient terminal configured to exchange the medicine-taking information with the server, and request a change of a medicine-taking schedule or input actual medicine-taking information; and a medical team terminal configured to transmit a final medicine-taking schedule to the server, wherein the final medicine-taking schedule includes information as to whether to change the medicine-taking schedule, wherein the information is based on the medicine-taking schedule change request or the actual medicine-taking information received from the patient terminal.

### BRIEF DESCRIPTION OF THE DRAWINGS

The above and other objects, features and advantages of the present invention will be more clearly understood from the following detailed description taken in conjunction with the accompanying drawings.

FIG. 1 depicts a system for changing a medicine-taking schedule according to an embodiment of the present invention.

FIG. 2 depicts a medicine-taking schedule management server according to an embodiment of the present invention.

FIG. 3 is a diagram schematically showing the configuration of a patient terminal according to an embodiment of the present invention.

FIG. 4 is a flowchart showing a method for changing a medicine-taking schedule according to an embodiment of the present invention.

FIG. 5 is a flowchart showing a method for changing a medicine-taking schedule according to another embodiment of the present invention.

FIG. 6 depicts a patient terminal including a request for the change of a medicine-taking schedule according to an embodiment of the present invention.

FIG. 7 depicts a medical team terminal including a response to a medicine-taking schedule change request according to an embodiment of the present invention.

### DETAILED DESCRIPTION

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

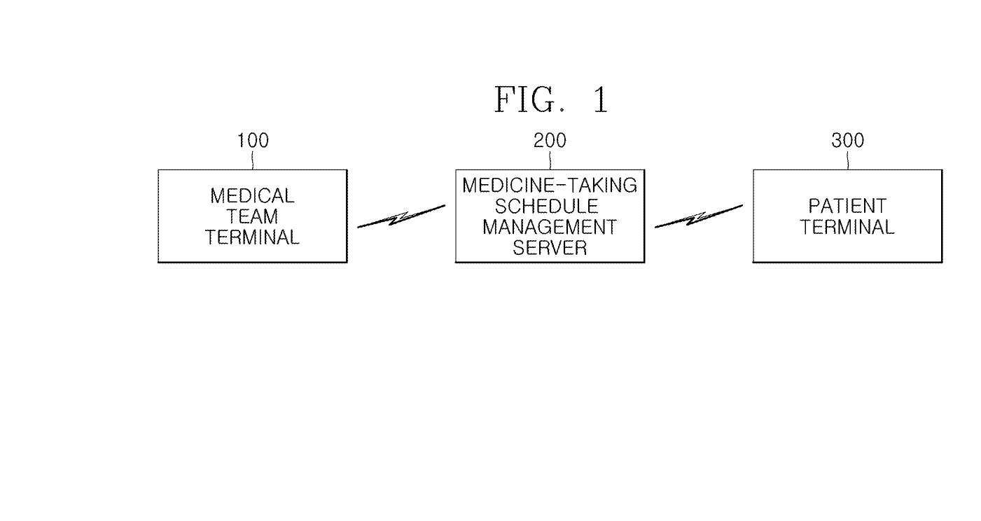

FIG. 1 depicts a system for changing a medicine-taking schedule according to an embodiment of the present invention. As shown in the drawing, the system for changing a medicine-taking schedule according to an embodiment of the present invention includes a medical team terminal 100, a medicine-taking schedule management server 200, and a patient terminal 300.

The medical team terminal 100 and the patient terminal 300 are devices for providing a medical supply information service, a medical supply-taking guide service, and the like for medicine-taking management for a user. Terminals 100, 300 may be implemented using any of a variety of terminals such as a mobile phone, a personal digital assistant (PDA) phone, a Personal Communications Service (PCS) phone, an International Mobile Telecommunications-2000 (IMT-2000) terminal, a smartphone, a laptop computer, a notepad, and the like.

The medical team terminal 100 and the patient terminal 300 may be mutually connected to a network (e.g., via Broadband Wireless Access (BWA)). The network may be implemented using any of a variety of wired or wireless environments such Code Division Multiple Access (CDMA), Wideband Code Division Multiple Access (W-CDMA)-type third generation or higher wireless communication technology, to name a few.

The medical team terminal 100 refers to a terminal used by a medical team (e.g., a doctor, nurse, pharmacists, a medical assistant, a health care professional, and the like) providing a medical service, and functions to input a prescription and comments about medicine-taking, and to transfer them to the medicine-taking schedule management server 200.

The patient terminal 300 is a terminal used by a patient, caregiver, or other individual who is provided with the medical service. Such a user performs functions of receiving and checking a medicine-taking schedule, checking comments provided by the medical team terminal 100, requesting a change of the medicine-taking schedule, inputting the details of an actually taken medicine, and receiving and displaying a changed medicine-taking schedule.

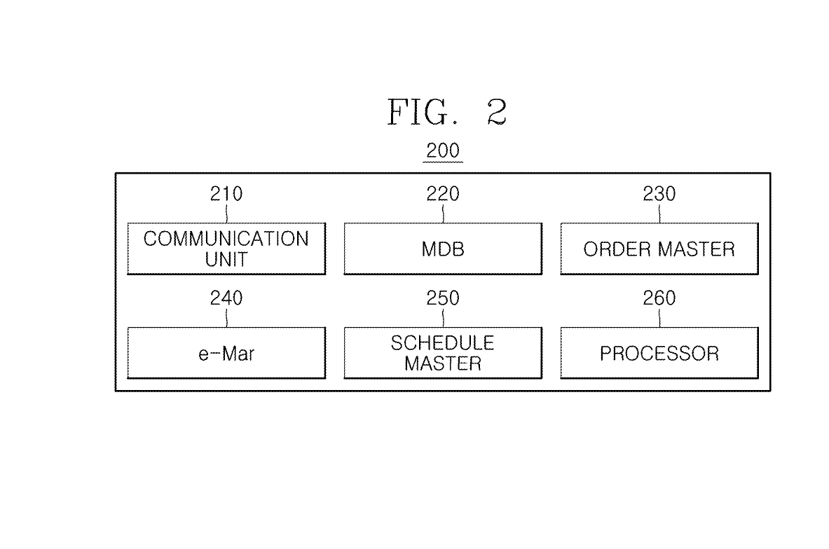

The medicine-taking schedule management server 200 may be connected both to the medical team terminal 100 and to the patient terminal 300 through a network, and may receive, store, and transfer information among the terminals. Further, the server 200 may store the identification information of the patient, for example. Such information includes gender, age, phone number, past medicine-taking history information, prescription, medical supplies, and the like. Detailed configuration and operation of the medicine-taking schedule management server 200 will be described in more detail below with reference to FIG. 2.

FIG. 2 depicts a medicine-taking schedule management server according to an embodiment of the present invention. The medicine-taking schedule management server 200 includes a communication unit 210, a MDB 220, an order master 230, an electronic Medication Administration Record (eMAR) memory 240, and a schedule master 250.

The communication unit 210 performs data communication with both the medical team terminal 100 and the patient terminal 300 through the network. Accordingly, the communication unit 210 allows the medicine-taking schedule management server 200 to receive and store information input from one terminal, and to transfer the input information to the other terminal if necessary.

The medicine database (MDB) 220 is a database (DB) for storing information about medicine-taking, such as a form, a route (medicine absorption route in a body), a medicine-taking time, and a medicine-taking time interval, among others.

The order master 230 is a DB for managing pieces of data about medicine-taking, based on the information stored in the MDB 220. The eMAR memory 240, which is configured to store medicine-taking information of each patient, stores information such as a medicine-taking time, the name of a taken medicine, and the dosage of the taken medicine. The schedule master 250 is a DB for storing a medicine-taking schedule of the patient. Further, the schedule master 250 may store the identification information of the patient, for example, the age, gender, phone number, past medicine-taking history information, prescription, and medical supplies of the patient.

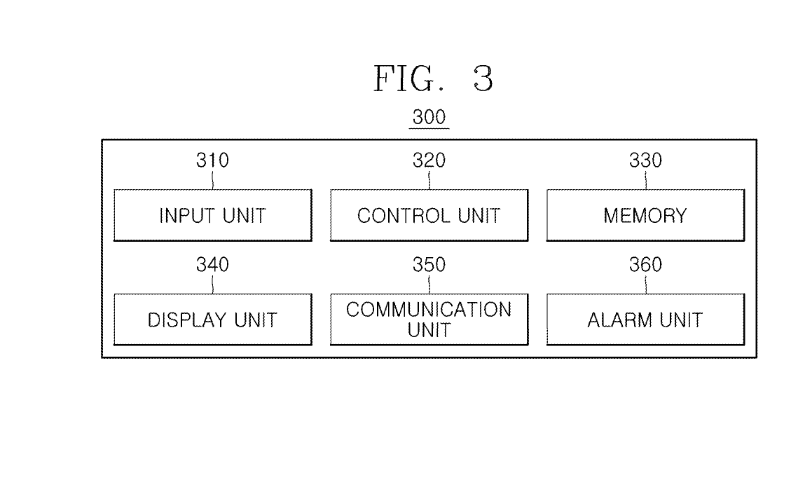

FIG. 3 is a diagram schematically showing the configuration of a patient terminal according to an embodiment of the present invention. The patient terminal 300 includes input unit 310, a control unit 320, a memory 330, a display unit 340, a communication unit 350, and an alarm unit 360.

The input unit 310 generates input data required by a user to control the operation of the terminal. The input unit 310 may be implemented using a keypad, a dome switch, a touch pad (resistive/capacitive type), a jog wheel, a jog switch, or the like.

The control unit 320 controls the overall operation of the patient terminal 300, and performs, for example, related control and processing for a voice call, data communication, a video call, etc. The control unit 320 may perform pattern recognition processing that enables a written input or a touch input to be recognized as characters.

The memory 330 may store a program for the operation of the control unit 320, and store pieces of input/output data. The memory 330 may include at least one type of storage medium such as a flash memory type, a hard disk type, a multimedia card micro type, card-type memory (e.g., Secure Digital (SD) or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, a magnetic disk, and an optical disk.

The display unit 340 displays (outputs) information processed by the patient terminal 300. For example, when the patient terminal 300 is in a call mode, the display unit 340 displays a User Interface (UI) or a Graphical User Interface (GUI) related to a call. When the patient terminal 300 is in a video call mode or an image capturing mode, the display unit 340 displays a captured image and/or a received image, or UI or GUI.

The display unit 340 may include at least one of a liquid crystal display (LCD), a thin film transistor-liquid crystal display (TFT LCD), an organic light-emitting diode (OLED), a flexible display, or a three-dimensional (3D) display.

When the display unit 340 and a sensor for sensing a touch action (hereinafter referred to as a “touch sensor”) form a mutual-layered structure (hereinafter referred to as a “touch screen”), the display unit 340 may also be used as an input device as well as an output device.

The touch sensor may be configured to convert a variation in pressure applied to a specific portion of the display unit 340 or a variation in capacitance into an electrical input signal.

The communication unit 350 may include one or more modules enabling wireless communication between the patient terminal 300 and a wireless communication system. For example, the communication unit 350 may include a broadcast reception module, a mobile communication module, a wireless Internet module, a short-range communication module, a location information module, etc.

Among the modules, the wireless Internet module denotes a module for accessing the Internet wirelessly, and may be installed inside or outside the patient terminal 300. Wireless Internet technology, Wireless LAN (WLAN) such as Wi-Fi, Wireless broadband (Wibro), World Interoperability for Microwave Access (Wimax), or High Speed Downlink Packet Access (HSDPA) may be used.

The short-range communication module denotes a module for short-range communication. Examples of short-range communication technology that may be implemented include Bluetooth, Radio Frequency Identification (RFID), Infrared Data Association (IrDA), Ultra Wideband (UWB), or Zig Bee.

The alarm unit 360 outputs a signal for providing notification of the generation of an event in the patient terminal 300. Examples of events generated in the mobile terminal include call signal reception, message reception, key signal input, touch input, etc. The alarm unit 360 may also output a signal for providing notification of generation of an event in forms, other than a video signal or an audio signal, for example, in the form of a vibration. The video signal or the audio signal may also be output via the display unit 340 or an audio output module.

Although the above description is related to the components of the patient terminal 300, at least a part of the described components may be similarly implemented in the medical team terminal 100.

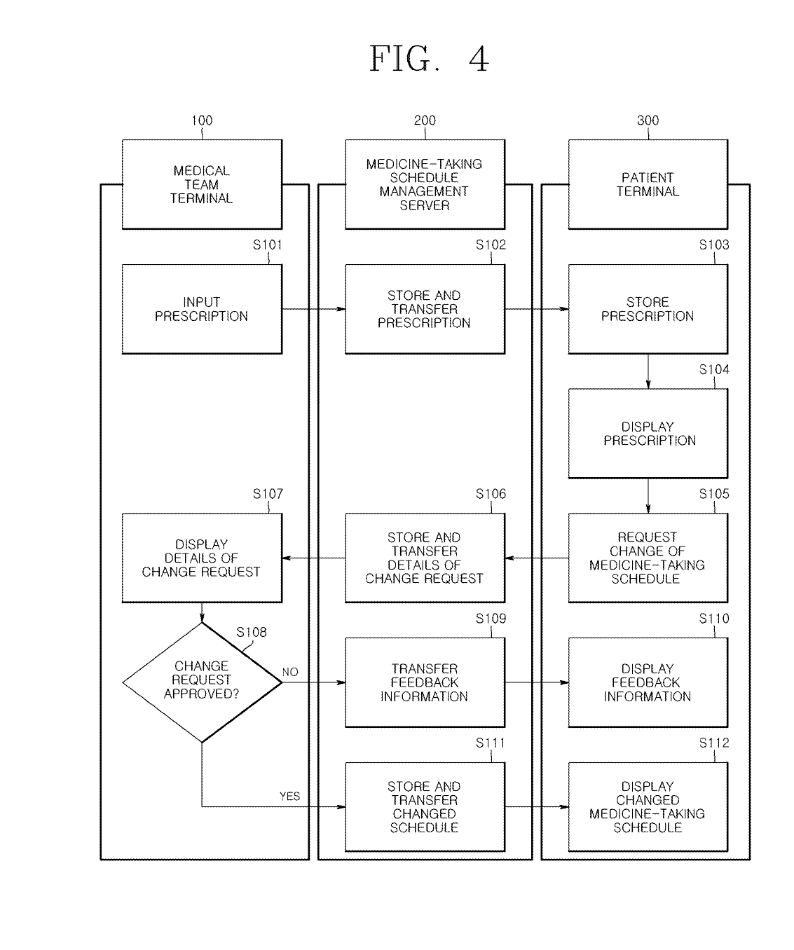

FIG. 4 is a flowchart showing a method for changing a medicine-taking schedule according to an embodiment of the present invention. Referring to FIG. 4, the medical team terminal 100 inputs a prescription at block S101, and transfers the prescription to the medicine-taking schedule management server 200 through a communication unit. The prescription includes information such as the name of a medicine to be taken, a medicine-taking time, directions for the taking of the medicine, patient information, a prescription transfer date, and a prescription transfer time. The prescription may also be generated by scanning a Quick Response (QR) code containing medicine-taking information.

The medicine-taking schedule management server 200 receives the prescription, stores the prescription therein, and transfers the prescription to the patient terminal 300 at block S102. Next, the patient terminal 300 stores the received prescription at block S103, and displays it on the display unit of the patient terminal at block S104. Next, the user of the patient terminal requests the change of a medicine-taking schedule inscribed on the prescription displayed on the display unit at block S105. The request for the change of a medicine-taking schedule may be created based on the medicine-taking time input by the patient, or the time randomly input by the patient.

The details of the change of a medicine-taking schedule may include a change in, for example, a medicine-taking time or the dosage of a medicine. Depending on the personal life style, age, and medicine-taking history of each individual patient who takes a medicine, the patient may request a change of a medicine-taking schedule suitable for themselves. Further, the change of a medicine-taking schedule may be requested even when the physical condition of the patient has gradually improved for a medicine-taking period and then the patient desires to reduce their dosage. Furthermore, when the patient does not desire to change his or her medicine-taking schedule, they may take the medicine according to the received medicine-taking schedule.

If necessary, the patient may provide a reason for the request for the change of a medicine-taking schedule through the patient terminal 300, and transmit the reason to the medical team terminal 100.

The request for the change of a medicine-taking schedule, which has been input via the above procedure, is transferred from the patient terminal 300 to the medicine-taking schedule management server 200 through the communication unit 350. The medicine-taking schedule management server 200 stores the details of the change request received from the patient terminal 300, and transfers the details of the change request to the medical team terminal 100 at block S106.

The medical team terminal 100 receives the details of the medicine-taking schedule change request and displays the details on the display unit at block S107. The medical team determines whether to approve the medicine-taking schedule change request in consideration of the details of the medicine-taking schedule change request, and the age, medicine-taking history, and physical characteristics of the patient at block S108.

When the medical team does not approve the medicine-taking schedule change request of the patient, a reason or a comment for the denial of the medicine-taking schedule change request is created as feedback information, and the medicine-taking schedule management server 200 transfers the feedback information to the patient terminal 300 at block S109. The patient terminal 300 receives the feedback information and displays it on the display unit 340 at block S110.

When the medical team approves the medicine-taking schedule change request of the patient, the medicine-taking schedule management server 200 stores the changed medicine-taking schedule with the approval of the medicine-taking schedule change request, and transfers the changed medicine-taking schedule to the patient terminal 300 at block S111. The patient terminal 300 receives the changed medicine-taking schedule and displays it on the display unit 340 at block S112.

Further, each of the original medicine-taking schedule and the change-requested medicine-taking schedule may include one or more sub-schedules.

Notification of the medicine-taking time is provided to the patient terminal 300 via an alarm at the medicine-taking time determined via the above procedure in combination with a voice, text, or other message. Further, depending on the setting of the patient terminal 300, a medicine-taking schedule notification service may be deactivated or the provision of the corresponding service may be denied. The alarm may be provided in such a way as to display a message, indicating that a medicine is to be taken, on the patient terminal 300 at a designated medicine-taking time in consideration of the medicine-taking time of the patient.

Further, the advertisements of the corresponding hospital and medical devices may be attached to a given medicine-taking schedule message depending on the type of medicine (drug) or the name of disease of the patient, and may then be used for marketing. Alternatively, Internet websites indicating the basic information, symptom, cause, complications, and prevention of a disease, and information about food, physical exercise, and finger-pressure therapy, which are effective in treating the disease, may be provided. The corresponding website may be accessed according to the selection of the user and then desired information may be viewed.

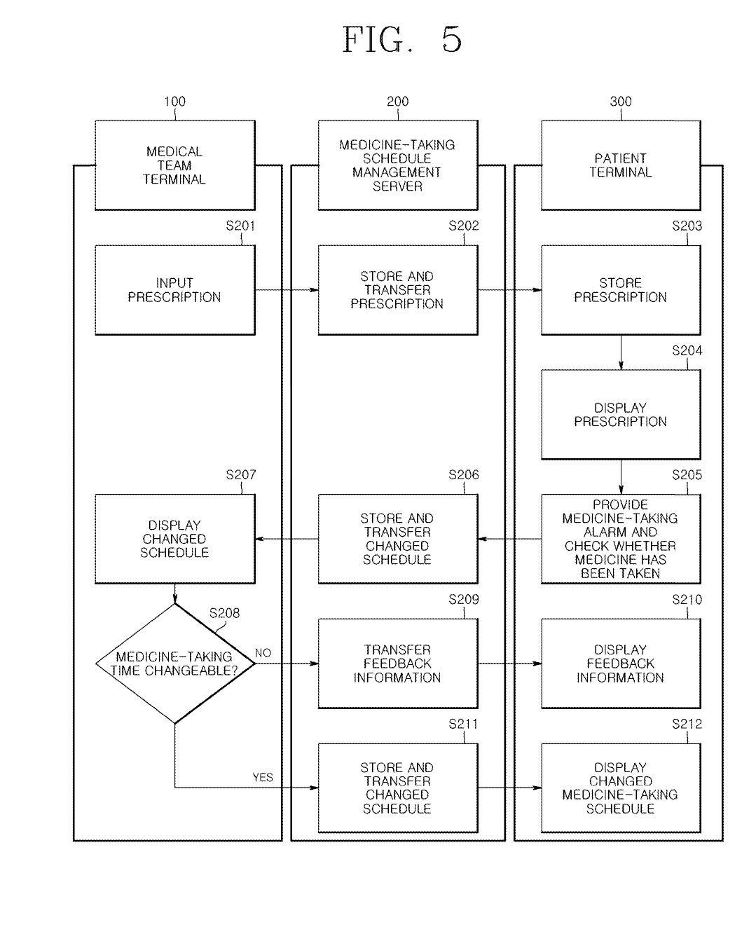

FIG. 5 is a flowchart showing a method for changing a medicine-taking schedule according to another embodiment of the present invention. Referring to FIG. 5, the medical team terminal 100 inputs a prescription at block S201, and transfers the prescription to the medicine-taking schedule management server 200 through the communication unit. The prescription includes information such as the name of a medicine to be taken, a medicine-taking time, directions for the taking of the medicine, patient information, a prescription transfer date, and a prescription transfer time.

The medicine-taking schedule management server 200 receives the prescription, stores the prescription therein, and transfers the prescription to the patient terminal 300 at block S202. Next, the patient terminal 300 stores the received prescription at block S203, and displays it on the display unit of the patient terminal at block S204.

Next, the patient terminal 300 notifies the patient of his or her designated medicine-taking time via an alarm, and displays a window, allowing the patient to check whether he or she has taken the medicine, on the display unit of the patient terminal 300 at block at S205. If information about whether the patient has taken the medicine is not checked at the designated medicine-taking time, a medicine taken by the patient may be checked in a medicine-taking schedule item after a predetermined period of time has elapsed, and checked information may be transmitted to the medicine-taking schedule management server 200. Furthermore, if the patient has taken the medicine even before the medicine-taking time, he or she may input both information, indicating that the medicine has been taken, and information about the time at which the patient took the medicine into the medicine-taking schedule item, and transmit the input information to the medicine-taking schedule management server 200. For the reliability of input of medicine-taking information, information about whether the patient has taken the medicine may be limitedly checked only within the date corresponding to that day and the previous day.

The information about the medicine-taking schedule input via the above procedure is transmitted to the medicine-taking schedule management server 200 through the communication unit and is stored therein. The medicine-taking schedule management server 200 transfers the medicine-taking schedule input by the patient to the medical team terminal 100 at block S206.

The medical team terminal 100 receives the actual medicine-taking schedule and displays it on the display unit at block S207. The medical team determines whether to approve a request for the change of the medicine-taking schedule in consideration of the details of the medicine-taking schedule change request, and the age, medicine-taking history, and physical characteristics of the patient at block S208.

When the medical team does not approve the medicine-taking schedule change request of the patient in consideration of the medicine-taking schedule and situation of the patient, a reason or a comment for the denial of the medicine-taking schedule change request is created as feedback information, and the medicine-taking schedule management server 200 transfers the feedback information to the patient terminal 300 at block S209. The patient terminal 300 receives the transferred information and displays it on the display unit at block S210.

When the medical team approves the changed medicine-taking schedule of the patient as a new medicine-taking schedule, the medicine-taking schedule management server 200 stores the approved changed medicine-taking schedule, and transfers the changed medicine-taking schedule to the patient terminal 300 at block S211. The patient terminal 300 receives the changed medicine-taking schedule and displays it on the display unit at block S212.

An alarm is set at the medicine-taking time determined by the above procedure in combination with a voice or text, for example, and then notification of the medicine-taking time is provided to the patient terminal 300 via the alarm. Further, depending on the setting of the patient terminal 300, a medicine-taking schedule notification service may be deactivated or the provision of the corresponding service may be denied.

The alarm may be provided in such a way as to display a message, indicating that a medicine is to be taken, on the patient terminal 300 at a designated medicine-taking time in combination with a voice or text in consideration of the medicine-taking time of the patient.

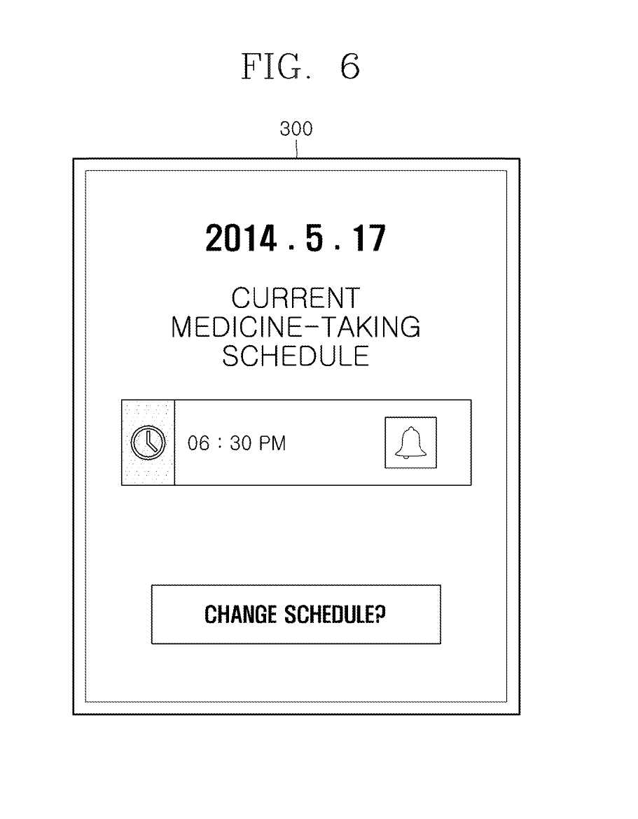

FIG. 6 depicts a patient terminal including a request for the change of a medicine-taking schedule according to an embodiment of the present invention. As shown in the drawing, on the patient terminal 300, a current medicine-taking schedule is displayed, and an alarm is set to ring at the corresponding medicine-taking time. When the patient requests the change of a medicine-taking schedule through the patient terminal 300, and selects a medicine-taking schedule change icon, a time desired to be changed may be selected. In this case, the current medicine-taking time may also be displayed.

If the selection of the medicine-taking time desired to be changed has been completed, the details of selection are transferred to the medical team terminal 100 through the medicine-taking schedule management server 200.

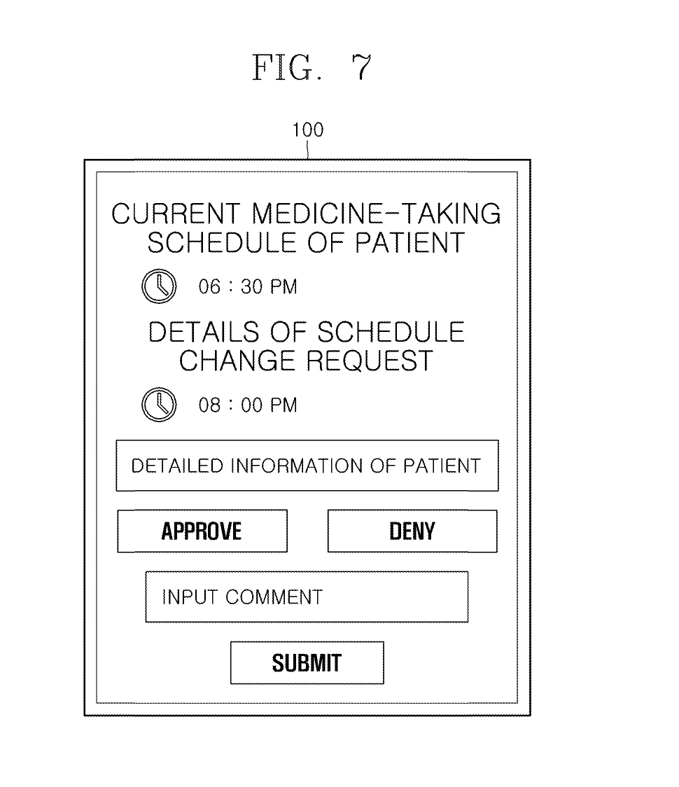

FIG. 7 depicts a medical team terminal including a response to a medicine-taking schedule change request according to an embodiment of the present invention. As shown in the drawing, the current medicine-taking schedule of a patient and the time of the medicine-taking schedule desired to be changed are displayed on the medical team terminal 100. Further, by way of selection, the detailed information of the patient may be viewed.

When the medical team approves the medicine-taking schedule change request of the patient, the medicine-taking time is reset to the time of the medicine-taking schedule requested by the patient. Accordingly, an alarm rings on the patient terminal 300 at the reset of the medicine-taking time. Further, when the medical team does not approve the medicine-taking schedule change request of the patient, the time of the medicine-taking schedule requested by the patient is not reflected, and then the existing medicine-taking schedule is maintained.

A method performed at a terminal of a medical team user for changing a medicine-taking schedule, the method comprises generating a first medicine-taking schedule, transmitting the first medicine-taking schedule to a terminal of a patient, receiving a medicine-taking schedule change request from the terminal of the patient and changing e the first medicine-taking schedule to a second medicine-taking schedule when a time parameter of first medicine-taking schedule is not within a threshold value of a time parameter of the second medicine-taking schedule.

The method further comprises generating the first medicine-taking schedule based on an input received from a user of the terminal of the medical team.

The method further comprising generating the first medicine-taking schedule by scanning a Quick Response (QR) code associated with medicine-taking information.

The second medicine-taking schedule is generated based on a time at which the patient takes a medicine.

The second medicine-taking schedule is generated using input provided by the patient.

The changing the first medicine-taking schedule to the second medicine-taking schedule comprises calculating a time difference between the time parameter of the first medicine-taking schedule and the time parameter of the the second medicine-taking schedule; and determining whether the time difference is not within the threshold value.

The method comprise transmitting the first medicine-taking schedule and the second medicine-taking schedule to the medical team terminal when the time difference is within the threshold value.

The method further comprises receiving, by a medicine-taking schedule management server, a third medicine-taking schedule, corresponding to a changed medicine-taking schedule from the medical team terminal, storing, by the medicine-taking schedule management server, the third medicine-taking schedule, and transmitting, by the medicine-taking schedule management server, the third medicine-taking schedule to the terminal of the patient.

The method further comprises generating a third medicine taking schedule, based on both the first medicine-taking schedule and the second medicine-taking schedule, when the time difference is within the threshold value and transmitting the third medicine-taking schedule to the terminal of the medical team terminal.

The method further comprises receiving confirmation of the third medicine-taking schedule from the terminal of the medical team, storing the third medicine-taking schedule that is confirmed and transmitting the third medicine-taking schedule to the terminal of the patient.

The first medicine-taking schedule includes one or more first sub-schedules, and the second medicine-taking schedule includes one or more second sub-schedules.

The method comprises storing the second medicine-taking schedule in a medicine-taking schedule management server. when the terminal medical team approves the medicine-taking schedule change request.

The method comprises setting an alarm on the terminal of the patient according to the second medicine-taking schedule when the terminal of the medical team approves the medicine-taking schedule change request.

A system for changing a medicine-taking schedule, comprises a server configured to store medicine-taking information of a patient, a patient terminal configured to exchange the medicine-taking information with the server, and request a change of a medicine-taking schedule or input actual medicine-taking information and a medical team terminal configured to transmit a final medicine-taking schedule to the server.

The final medicine-taking schedule includes information as to whether to change the medicine-taking schedule, the information is based on the medicine-taking schedule change request or the actual medicine-taking information received from the patient terminal.

The server includes a medicine database having medicine-taking information including a form, route, a medicine-taking time, and a medicine-taking time interval.

The server includes an order master for managing data about each individual patient for medicine-taking based on the information stored in the medicine database. The server further comprises an electronic Medication Administration Record (eMAR) memory for storing the medicine-taking information. The server comprises a schedule master for storing the final medicine taking schedule.

Regardless of whether to approve the medicine-taking schedule change request of the patient, the medical team may create a comment if desired or necessary, and transmit the comment to the patient terminal 300.

By the above process, there is an advantage in that communication between the medical team and the patient can be performed, a medicine-taking schedule suitable for each individual patient can be adjusted, and information about the medicine-taking of the patient can be monitored.

As described above, the method and system for changing a medicine-taking schedule according to the embodiments of the present invention are advantageous in that, when a patient requests the change of a medicine-taking schedule, and a medical team agrees with requested change details, an alarm is set for the changed medicine-taking schedule, thus inducing the patient to take a medicine at the set time.

Further, the method and system for changing a medicine-taking schedule according to the embodiments of the present invention are advantageous in that, when a medical team approves the change of a medicine-taking schedule in consideration of actual medicine-taking information of a patient, an alarm is set for the changed medicine-taking schedule, thus inducing the patient to take a medicine at the set time.

The above-described details may be changed and modified by those skilled in the art to which the present invention pertains, within the spirit and scope of essential features of the present invention. Therefore, embodiments disclosed in the present invention are not intended to limit the technical spirit of the present invention and are intended to describe the present invention, and the scope of the technical spirit of the present invention is not limited by those embodiments. The scope of the present invention should be interpreted by the accompanying claims, and the technical spirit of equivalents thereof should be interpreted as being included in the scope of the present invention.

What is claimed is:

1. A method for changing a medicine-taking schedule, the method comprising:
generating a first medicine-taking schedule;
transmitting the first medicine-taking schedule to a terminal of a patient;
receiving a second medicine-taking schedule from the terminal of the patient; and
determining whether to change the first medicine-taking schedule by comparing the first medicine-taking schedule with the second medicine-taking schedule.

2. The method of claim 1, further comprising
receiving an order from a terminal of the medical team;
generating the first medicine-taking schedule based on the order.

3. The method of claim 1, further comprising generating the first medicine-taking schedule by scanning a Quick Response (QR) code associated with medicine-taking information.

4. The method of claim 1, wherein the second medicine-taking schedule is generated based on a time at which the patient takes a medicine.

5. The method of claim 1, wherein the second medicine-taking schedule is generated using input provided by the patient.

6. The method of claim 1, wherein the changing the first medicine-taking schedule to the second medicine-taking schedule comprises:
calculating a time difference between the time parameter of the first medicine-taking schedule and the time parameter of the second medicine-taking schedule; and
determining whether the time difference is within the threshold value.

7. The method of claim 6, further comprising:
transmitting the first medicine-taking schedule and the second medicine-taking schedule to the medical team terminal when the time difference not within the threshold value.

8. The method of claim 7, further comprising:
receiving a third medicine-taking schedule corresponding to a changed medicine-taking schedule from the medical team terminal;
storing the third medicine-taking schedule; and
transmitting the third medicine-taking schedule to the terminal of the patient.

9. The method of claim 6, further comprising:
generating a third medicine-taking schedule, based on both the first medicine-taking schedule and the second medicine-taking schedule, when the time difference not within the threshold value; and
transmitting the third medicine-taking schedule to the terminal of the medical team.

10. The method of claim 9, further comprising:
receiving confirmation of the third medicine-taking schedule from the terminal of the medical team;
storing the third medicine-taking schedule that is confirmed; and
transmitting the third medicine-taking schedule to the terminal of the patient.

11. The method of claim 1, wherein:
the first medicine-taking schedule includes one or more first sub-schedules, and
the second medicine-taking schedule includes one or more second sub-schedules.

12. The method of claim 1, further comprising:
storing the second medicine-taking schedule in a medicine-taking schedule management server when the terminal medical team approves the medicine-taking schedule change request.

13. The method of claim 1, further comprising:
setting an alarm on the terminal of the patient according to the third medicine-taking schedule when the terminal of the medical team approves the medicine-taking schedule change request.

14. A system for changing a medicine-taking schedule, comprising:
a server configured to store medicine-taking information of a patient;
a patient terminal configured to exchange the medicine-taking information with the server, and request a change of a medicine-taking schedule or input actual medicine-taking information; and
a medical team terminal configured to transmit a final medicine-taking schedule to the server, wherein the final medicine-taking schedule includes information as to whether to change the medicine-taking schedule, wherein the information is based on the medicine-taking schedule change request or the actual medicine-taking information received from the patient terminal.

15. The system of claim 14, wherein the server includes a medicine database having medicine-taking information including a form, route, a medicine-taking time, and a medicine-taking time interval.

16. The system of claim 15, wherein the server includes an order master for managing data about each individual patient for medicine-taking based on the information stored in the medicine database.

17. The method of claim 14, further comprising an electronic Medication Administration Record (eMAR) memory for storing the medicine-taking information.

18. The system of claim 14, further comprising a schedule master for storing the final medicine-taking schedule.

19. A medicine-taking schedule management server, comprising:
a transceiver for transmitting a first medicine-taking schedule to a terminal of the patient and receiving a second medicine-taking schedule from the terminal of the patient; and
a processor for generating the first medicine-taking schedule, and executing a program for determining whether to change the first medicine-taking schedule by comparing the first medicine-taking schedule with the second medicine-taking schedule.
